(19) United States
(12) Patent Application Publication
(10) Pub. No.: US 2025/0244607 A1
(43) Pub. Date: Jul. 31, 2025

(54) SELF-TETHERING EYEGLASSES

(71) Applicant: Tanner Zellmer, Seminole, FL (US)

(72) Inventor: Tanner Zellmer, Seminole, FL (US)

(21) Appl. No.: 18/703,573

(22) PCT Filed: Oct. 21, 2022
(86) PCT No.: PCT/US2022/047486

§ 371 Date: Apr. 22, 2024

Related U.S. Application Data
(60) Provisional application No. 63/270,175, filed on Oct. 21, 2021.

(51) Int. Cl. G02C 3/00; H01F 7/02

(52) U.S. Cl. CPC G02C 3/006; H01F 7/0263; G02C 2200/02

(57) ABSTRACT

Self-tethering eyeglasses that include a pair of distal portions located on the terminal end of the temples of the eyeglasses, wherein the pair of distal portions each include a permanent magnet coupled thereto or formed thereon and are attached to a flexible cable that is freely disposed and movable within an internal channel formed within the temples and include a flange member coupled thereto that restricts the cable from being removed from the temple. As such, a user may remove the distal portions of the temples and magnetically couple them together to secure the eyeglasses to the head or neck area of the user.

### FIELD OF THE INVENTION

The present invention relates generally to devices operably configured to retain eyeglasses on a user and, more particularly, relates to a pair of tethers extendable and retractable from a pair of eyeglasses.

### BACKGROUND OF THE INVENTION

Many users utilize eyeglasses for vision correction, safety reasons, and/or eye protection. Most eyeglasses, like those shown in the figures, consist of a pair of rims that each hold a lens in place, a bridge that connects the rims together, nose pads or supports that form part of or are connected to the bridge or rims, and a pair of temples that are hindgedly coupled to the rims. Many of these eyeglasses are expensive if replacement is required and would otherwise cause significant inconvenience or problems to the user if lost or damaged due to misplacement or misuse by the user. As such, many known devices have been produced retain the eyeglasses to a user's head and/or neck and otherwise prevent the pair of eyeglasses from being misplaced, misused, or otherwise being removed from the user's head or neck unless selectively desired by the user. Specifically, these known devices utilize tether(s) or strap(s) to retain the eyeglasses to a user's head or neck.

For example, some known tethering eyeglass tethering devices are limited in shape and size, thereby preventing their use on some users. Other known tethering devices are externally coupled to or retrofitted to a pair of conventional eyeglasses. These devices however are routinely lost, can also be expensive, are unsightly, and prevent or inhibit conventional use of the eyeglasses, which many users find problematic. Other known tethering devices are incorporated into a pair of temples, but are complicated and intricate in design, which increases the cost of the eyeglasses and are difficult and costly to manufacture and assemble. Many of these known tethering devices are also difficult and/or inefficient to extend the tethers from the temples of the eyeglasses or to connect the tethers together if configured to separate.

Therefore, a need exists to overcome the problems with the prior art as discussed above.

### SUMMARY OF THE INVENTION

The invention provides a pair of eyeglasses, e.g., sunglasses, having temples each with a selectively removable wire inserted therein and with each end of the wires having a magnet coupled thereto and of an opposing polarity enabling the ends to operably and magnetically couple together.

With the foregoing and other objects in view, there is provided, in accordance with the invention, self-tethering eyeglasses that includes a left rim retaining a lens and a right rim retaining a lens and a left temple that is coupled to the left rim, has a left terminal free end, has a distal left portion including the left terminal free end, selectively removably fastened to an intermediate left end defining an intermediate left opening, and having a left magnet coupled thereto, and defines a left temple channel spanning within the left temple until terminating at the intermediate left opening and having a left flexible metallic cable freely disposed and movable within the left temple channel, wherein the left flexible metallic cable has the distal left portion coupled to an end thereon and has a flange member coupled thereto with a flange diameter less than a diameter of the left temple channel and greater than a diameter of the intermediate left opening. The eyeglasses also includes a right temple coupled to the right rim, a right terminal free end, a distal right portion including the right terminal free end, selectively removably fastened to an intermediate right end defining an intermediate right opening, and having a right magnet coupled thereto and operably configured magnetically coupled to the left magnet, and also defines a right temple channel spanning within the right temple until terminating at the intermediate right opening and having a right flexible metallic cable freely disposed and movable within the right temple channel, wherein the right flexible metallic cable have the distal right portion coupled to an end thereon and having a flange member coupled thereto with a flange diameter less than a diameter of the right temple channel and greater than a diameter of the intermediate left opening.

In accordance with a further feature of the present invention, the left flexible metallic cable is coaxially disposed within the left temple channel and the right flexible metallic cable is coaxially disposed within the right temple channel.

In accordance with another feature of the present invention, the left flexible metallic cable has the flange member coupled thereto disposed at a proximal terminal end that is opposite the end with the distal left portion coupled thereto and with the right flexible metallic cable having the flange member coupled thereto disposed at a proximal terminal end that is opposite the end with the distal right portion coupled thereto.

In accordance with yet another feature of the present invention, the left and right flexible metallic cables are of a braided and corrosion resistant.

In accordance with another feature, an embodiment of the present invention includes a proximal end of the left temple hingedly coupled to the left rim and a left temple length separating the proximal end of the left temple and the intermediate left end, wherein the left temple channel is at least 95% of the left temple length and also includes a proximal end of the right temple hingedly coupled to the right rim and a right temple length separating the proximal end of the right temple and the intermediate left end, wherein the right temple channel is at least 95% of the right temple length.

In accordance with a further feature of the present invention, the intermediate left opening is enclosed by the intermediate left end and the intermediate right opening is enclosed by the intermediate right end.

In accordance with an exemplary feature of the present invention, the distal left portion includes a planar surface with the left magnet disposed thereon and the distal right portion includes a planar surface with the right magnet disposed thereon.

In accordance with a further feature of the present invention, the distal left and right portions are each operably configured to be selectively and independently extended from the respective left and right temples on a tether translation path until the flange member of the flexible metallic cable reaches the respective intermediate left and right openings.

Also in accordance with the present invention, self-tethering eyeglasses are disclosed that includes a left rim retaining a lens and a right rim retaining a lens, a left temple coupled to the left rim, a left terminal free end, a distal left portion including the left terminal free end, selectively removably fastened to an intermediate left end defining an intermediate left opening, and having a left magnet coupled thereto, and wherein the left temple defines a left temple channel spanning within the left temple until terminating at the intermediate left opening and having a left flexible cylindrical cable freely disposed and movable within the left temple channel in a coaxial configuration, wherein the left flexible cylindrical cable has the distal left portion coupled to an end thereon and has a flange member coupled thereto and operably configured to restrict longitudinal movement of left flexible cylindrical cable when reaching the intermediate left end. The eyeglasses also includes a right temple coupled to the right rim, a right terminal free end, a distal right portion including the right terminal free end, selectively removably fastened to an intermediate right end defining an intermediate right opening, and having a right magnet coupled thereto and operably configured magnetically coupled to the left magnet, and with the right temple defining a right temple channel spanning within the right temple until terminating at the intermediate right opening and having a right flexible cylindrical cable freely disposed and movable within the right temple channel in a coaxial configuration, wherein the right flexible cylindrical cable has the distal right portion coupled to an end thereon and has a flange member coupled thereto and operably configured to restrict longitudinal movement of right flexible cylindrical cable when reaching the intermediate right end.

Although the invention is illustrated and described herein as embodied in self-tethering eyeglasses, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description. It should be understood that terms such as, “front,” “rear,” “side,” top,” “bottom,” and the like are indicated from the reference point of a viewer viewing the eyeglasses as seen in FIG. 1 of the figures.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the temples of the eyeglasses.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of self-tethering eyeglasses with two distal portions of the temples extended from the temples in accordance with one embodiment of the present invention;

FIG. 2 is a perspective view of the self-tethering eyeglasses in FIG. 1 with the two distal portions of the temples retracted and fastened to the temples in accordance with one embodiment of the present invention;

FIG. 3 is an elevational partially cross-sectional view of a temple of the eyeglasses in FIG. 2 along section line 2-2;

FIG. 4 is a perspective view of the self-tethering eyeglasses in FIG. 1; and

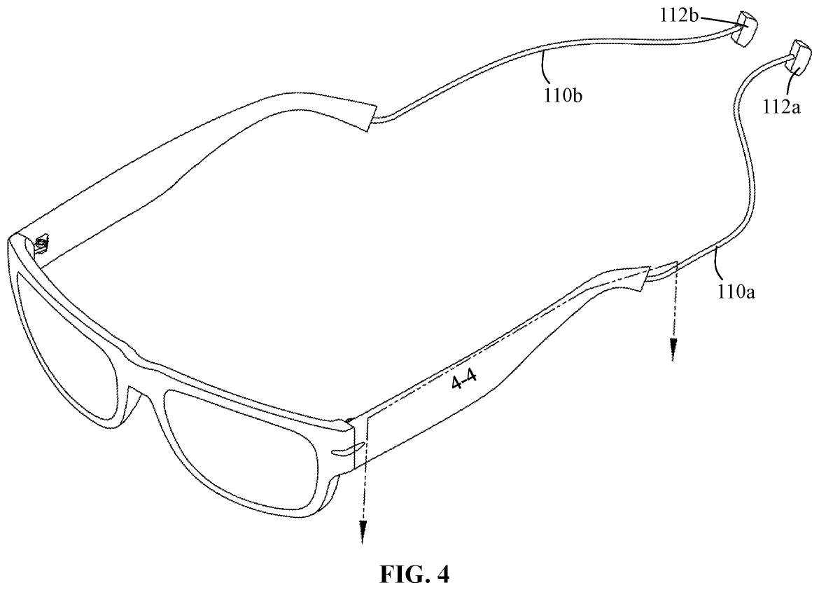

FIG. 5 is an elevational partially cross-sectional view of a temple of the eyeglasses in FIG. 4 along section line 5-5.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

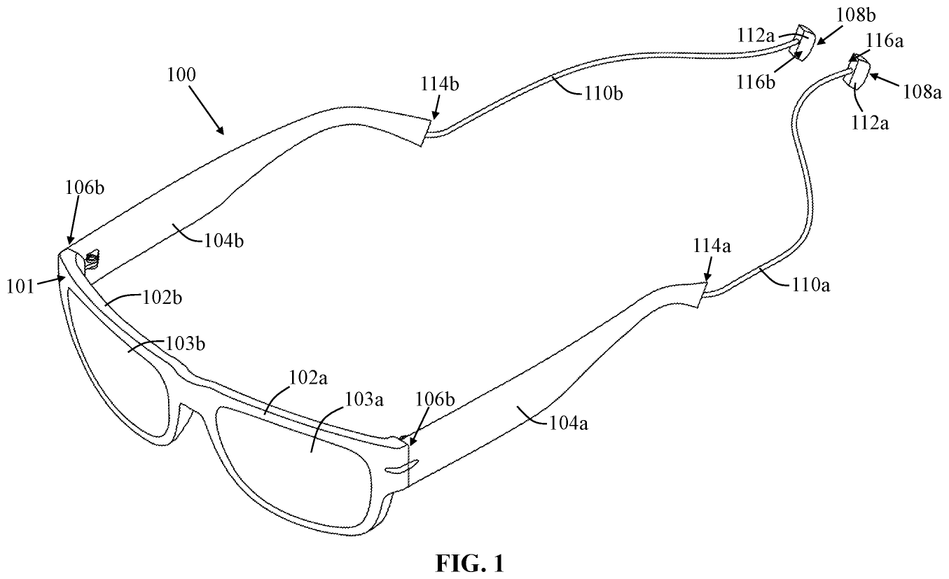

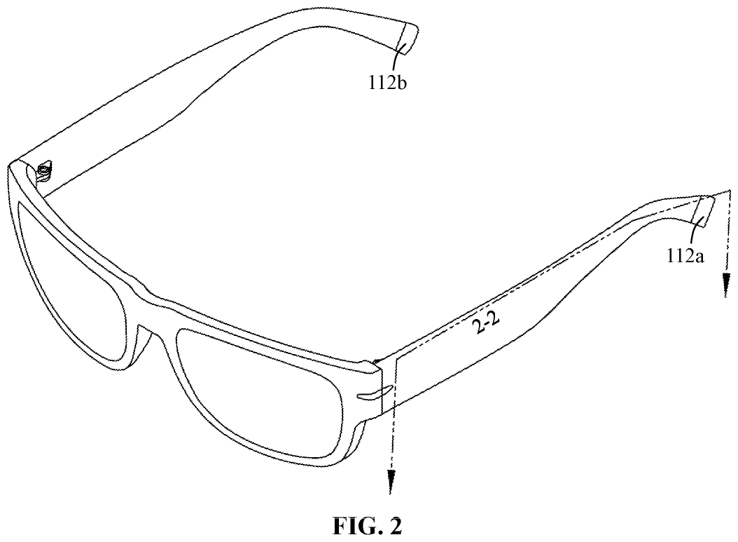

The present invention provides a novel and efficient self-tethering eyeglasses. Referring now to FIGS. 1-2, one embodiment of the present invention is shown in perspective views having cables 110a-b and portions 112a-b of the temples 104a-b selectively removed or extended and retracted, respectively. FIGS. 1-2, along with the other figures depicted herein, show several advantageous features of the present invention, but, as will be described below, the invention can be provided in several shapes, sizes, combinations of features and components, and varying numbers and functions of the components.

More specifically, the self-tethering eyeglasses 100 can be seen having an eyeglasses frame 101 that may be monolithically formed and may also include a pair of temples 104a-b, left and right rims 102a-b each retaining lenses 103a-b, a nose pad, etc., but beneficially includes portions 112a-b at the terminal end of the temples 104a-b that are selectively removable therefrom and magnetically couplable together in a quick, effective, and efficient manner that is not accomplished by the known eyeglass tethering devices. Each of the pair of temples 104a-b may have proximal ends 106a-b hingedly coupled to the frame or rims 102a-b. Each of the temples 104a-b have terminal free ends 108a-n, i.e., they are not connected to anything when the portions 112a-b are in a retracted configuration or when the user does not desire to magnetically coupled them together.

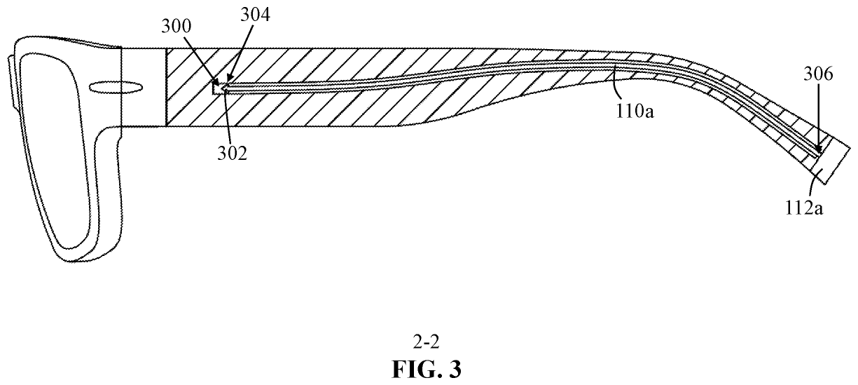

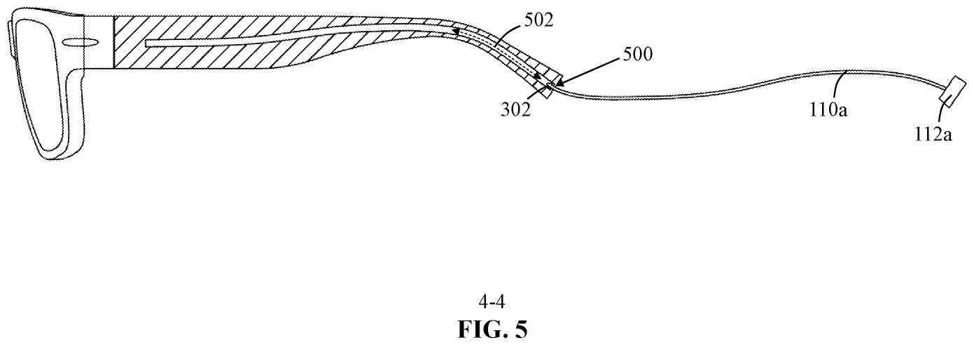

The temples 104a-b include intermediate ends 114a-b interposed between the proximal and terminal free ends 106a-b, 108a-b. With reference to FIG. 3 and FIG. 5 in combination with FIGS. 1-2, the intermediate ends 114a-b each define an opening 500 aperture that may be enclosed and enables a portion of cable to extend and retract therethrough. The opening 500 may be preferably slightly greater (i.e., 5%) in diameter than the diameter of the cables 110a-b, wherein the diameter and length of the cables 110a-b are preferably of the same dimensions. The pair of temples 104a-b also define an internal channel 300 that spans along a temple length separating the proximal and intermediate ends 106a-b, 114a-b and that terminates at the opening 500. The internal channel 300 may be completely enclosed and may also span the entire temple length or may, in other embodiments, span a portion of the temple length. The internal channel 300 may be molded into the temples 104a-b as a monolithic member or may be formed by joining two halves of a temple. The internal channel 300 may also be shaped to correspond with the shape of the cables 110a-b and may be slightly larger (i.e., 5%) in size than the diameter of the cables 110a-b to provide slight resistance when moving the cables 110a-b within the channels.

The distal left and right portions 112a-b, which also include the respective left or right terminal free end 108a-b, are beneficially selectively removably fastened to the respective intermediate left or right end 114a-b using, for example, a perimeter snap fit configuration or magnetic coupling configuration. The distal left and right portions 112a-b also each have respective left or right magnets 116a-b coupled thereto, wherein the left and right magnets 116a-b are operably configured to magnetically coupled with one another. In one embodiment, the magnets 116a-b may be N42 or N52 neodymium magnets and may have a magnetic strength ranging from approximately 5-25 mT to sufficiently keep the eyeglasses retained around the user's neck. In one embodiment, the entire outer surface of the distal left and right portions 112a-b are of a magnetic material. The distal left and right portions 112a-b may also be beneficially of a shape corresponding to the shape and dimensions of the temples 104a-b to provide an inconspicuous design when the distal left and right portions 112a-b are in a retracted configuration or position (as exemplified in FIG. 2) along a translation path (which is curvilinear once removed from the channel 300 so as to partially surround a user's neck). As seen in FIG. 1, the distal left portion 112a may also include a planar surface with the left magnet 116a disposed thereon and the distal right portion 112b includes a planar surface with the right magnet 116b disposed thereon, thereby effectuating a secure attachment of the distal left and right portions 112a-b.

The eyeglasses self-tethering device 100 also includes pair of substantially rigid, yet flexible, cables 110a-b that may be of a material, such as stainless steel, aluminum, or PVC. In one embodiment, the left and right flexible metallic cables 110a-b are of a braided and corrosion-resistant material to reduced degradation (particularly when used in an outside environment). Each of the cables 110a-b may be preferably of cylindrical shape to move easier within the channel 300 and provide comfort to the user. Further, the cables 110a-b are disposed within the internal channel 300 of the respective temples 104a-b. Said another way, each temple 104a-b defines a respective left and right temple channel 300 (e.g., as shown in FIG. 3) spanning within the respective left or right temple 104a-b until terminating at the respective intermediate left opening 500 (e.g., as shown in FIG. 5). Each channel 300 has a respective left or right flexible metallic cable 110a freely disposed and movable within the left temple channel 300, i.e., there are no external reels or attachments inhibiting or biasing movement of the cables 110a-b, thereby beneficially providing a low-cost, yet efficient and effective, solution to form self-tethering eyeglasses. The left and right flexible metallic cables 110a-b each respectively have the distal left and right portions 112a-b coupled to an end thereon using, for example, adhesive, one or more fasteners, or welding.

In one embodiment, the cables 110a-b each have a flange member (e.g., flange member 302) coupled thereto, wherein a flange diameter less than a diameter of the left temple channel 300 to enable movement therein and greater than a diameter of the intermediate left or right openings 500 to prevent movement therethrough. As such, a user will very simply and effectively extend or retract the cable 110a-b within the respective channel 300 when desired to be utilized or stowed, wherein the weight and strength of the cables 110a-b allows the cables 110a-b to be utilized repeatedly and effectively with minimal risk of malfunction. The cables 110a-b may have a first cable end 304 (that may be the terminal end) having the flange 302 (or “catch”) disposed and coupled proximal thereto, i.e., at or near (within 15-20% of the longitudinal length) of the proximal terminal end 300. The flange 302 is shaped and sized to be at least partially or completely disposed within the internal channel, but shaped and sized to be less than the aperture 500. The catch may be configured within the internal channel in a tongue-and-groove configuration. Said another way, the left flexible metallic cable 110a has the flange member 302 coupled thereto that may be disposed at a proximal terminal end 300 and that is opposite the end (e.g., end 306) with the distal left portion 112a coupled thereto. Similarly, the right flexible metallic cable 110b also has the flange member coupled thereto that may be disposed at a proximal terminal end that is opposite the end with the distal right portion 112b coupled thereto. The flange diameter is less than a diameter of the temple channel 300 and greater than a diameter of the intermediate openings 500.

In one embodiment (as best seen in FIG. 1 and FIG. 3), the proximal end 106a of the left temple 104a is hingedly coupled to the left rim 102a and has a left temple length separating the proximal end 106a of the left temple 104a and the intermediate left end 114a, wherein the left temple channel 300 is at least 95% of the left temple length (e.g., 125-175 mm). The proximal end 106b of the right temple 104b is also hingedly coupled to the right rim 102b and includes a right temple length separating the proximal end 106b of the right temple 104b and the intermediate left end 114b, wherein the right temple channel is at least 95% of the right temple length (e.g., 125-175 mm).

Also seen best in FIG. 1 and FIG. 3, the left and right flexible cables 110a-b may be coaxially disposed within the respective left and right temple channels 300. Said another way, the cables 110a-b are beneficially not in an overlapping configuration and moves linear or curvilinear (depending on the shape of the temples 104a-b) within the channel 300 or along the same axis defined by the channel 300 (which may also be cylindrical or an oblong shape). The cables 110a-n also include an end (e.g., end 306) with a permanent magnet 116a-b coupled proximal thereto. The magnets 116a-b (e.g., neodymium) on the ends of the cables 110a-b or portions 112a-b are of an opposing polarity operably configured to directly couple together in a magnetically fastened configuration. The pull strength on each of the magnets 116a-b may also range from approximately 100-1000 gauss or may otherwise resist uncoupling from one another upon being subjected to approximately 1-5 lbf.

With reference to FIG. 1, FIG. 3, and FIG. 5, the pair of tethering cables 110a-b are operably configured to beneficially and freely translate within the internal channel 300. Said another way, the magnets 116a-b or distal portions 112a-b may be disposed and/or sized such that they are not insertable into the internal channel 300 or opening 500, but, when the user does not desire to wear the eyeglasses 100, the user will remove one or both of cables 110a-b independent of one another and couple the distal portions 112a-b to one another with the magnets 116a-b. Said another way, the distal left and right portions 112a-b are each operably configured to be selectively and independently extended from the respective left and right temples 104a-b on a tether translation path (e.g., path 502 depicted in FIG. 5) until the flange member 302 of the flexible metallic cable 110a-b reaches the respective intermediate left and right openings 500. Said differently, the left and right flexible cables 110a-b each have the distal portion 112a-b coupled to an end thereon and may include the flange member 302 coupled to the cable 110a-b and operably configured to restrict longitudinal movement of cables 110a-b when reaching the respective intermediate end 114a-b or opening 500 defined thereon.

In preferred embodiments, the flexible tethering cables 110a-b are extendable and retractable (approximately 2-5 inches, or a portion of the temple length) within the temples 104a-b and can freely move within unless exclusively stopped by the catch (which may be formed as a flange). The magnets 116a-b may also be configured to be retained on the portions 112a-b (or a location proximal thereto) with a magnet of an opposing polarity.

Although exemplary dimensions and lengths utilized on the device 100 have been described and depicted, dimensions outside of said ranges may be utilized. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features. Further, although a specific order of executing process and utilization steps has been described and depicted, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

1. A self-tethering eyeglasses comprising:
a left rim retaining a lens and a right rim retaining a lens;
a left temple:
having a monolithic body coupled to the left rim and having an intermediate left end;
having a left terminal free end;
having a distal left portion including the left terminal free end, selectively removably solely, and directly fastened to the intermediate left end when in a retracted configuration and defining an intermediate left opening, and having a left magnet coupled thereto; and
defining a left temple channel spanning within the left temple until terminating at the intermediate left opening and having a left flexible and corrosion resistant metallic cable freely disposed and movable within the left temple channel, the left flexible metallic cable having the distal left portion coupled to an end thereon and having a flange member coupled thereto with a flange diameter less than a diameter of the left temple channel and greater than a diameter of the intermediate left opening; and
a right temple:
having a monolithic body coupled to the right rim and having an intermediate right end;
having a right terminal free end;
having a distal right portion including the right terminal free end, selectively removably, solely, and directly fastened to the intermediate right end when in the retracted configuration and defining an intermediate right opening, and having a right magnet coupled thereto and operably configured magnetically coupled to the left magnet; and
defining a right temple channel spanning within the right temple until terminating at the intermediate right opening and having a right flexible and corrosion resistant metallic cable freely disposed and movable within the right temple channel, the right flexible metallic cable having the distal right portion coupled to an end thereon and having a flange member coupled thereto with a flange diameter less than a diameter of the right temple channel and greater than a diameter of the intermediate right opening.

2. The self-tethering eyeglasses according to claim 1, wherein:
the left flexible metallic cable is coaxially disposed within the left temple channel and the right flexible metallic cable is coaxially disposed within the right temple channel.

3. The self-tethering eyeglasses according to claim 2, wherein:
the left flexible metallic cable having the flange member coupled thereto disposed at a proximal terminal end that is opposite the end with the distal left portion coupled thereto and with the right flexible metallic cable having the flange member coupled thereto disposed at a proximal terminal end that is opposite the end with the distal right portion coupled thereto.

4. The self-tethering eyeglasses according to claim 1, wherein:
the left and right flexible metallic cables are of a braided material.

5. The self-tethering eyeglasses according to claim 1, further comprising:
a proximal end of the left temple hingedly coupled to the left rim and a left temple length separating the proximal end of the left temple and the intermediate left end, wherein the left temple channel is at least 95% of the left temple length; and
a proximal end of the right temple hingedly coupled to the right rim and a right temple length separating the proximal end of the right temple and the intermediate left end, wherein the right temple channel is at least 95% of the right temple length.

6. The self-tethering eyeglasses according to claim 1, wherein:
the intermediate left opening is enclosed by the intermediate left end and the intermediate right opening is enclosed by the intermediate right end.

7. The self-tethering eyeglasses according to claim 1, wherein:
the distal left portion includes a planar surface with the left magnet disposed thereon and the distal right portion includes a planar surface with the right magnet disposed thereon.

8. The self-tethering eyeglasses according to claim 1, wherein:
the left flexible metallic cable having the flange member coupled thereto disposed at a proximal terminal end that is opposite the end with the distal left portion coupled thereto and with the right flexible metallic cable having the flange member coupled thereto disposed at a proximal terminal end that is opposite the end with the distal right portion coupled thereto.

9. The self-tethering eyeglasses according to claim 1, wherein:
the distal left and right portions are each operably configured to be selectively and independently extended from the respective left and right temples on a tether translation path until the flange member of the flexible metallic cable reaches the respective intermediate left and right openings.

10. A self-tethering eyeglasses comprising:
a left rim retaining a lens and a right rim retaining a lens;
a left temple:
having a monolithic body coupled to the left rim and having an intermediate left end;
having a left terminal free end;
having a distal left portion including the left terminal free end, selectively removably solely, and directly fastened to the intermediate left end when in a retracted configuration and defining an intermediate left opening, and having a left magnet coupled thereto; and
defining a left temple channel spanning within the left temple until terminating at the intermediate left opening and having a left substantially rigid, flexible, and cylindrical cable freely disposed and movable within the left temple channel in a coaxial configuration, the left flexible corrosion resistant cylindrical cable having the distal left portion coupled to an end thereon, of a substantially rigid material, and having a flange member coupled thereto, with a flange diameter less than a diameter of the left temple channel and greater than a diameter of the intermediate left opening, and operably configured to restrict longitudinal movement of left flexible cylindrical cable when reaching the intermediate left end; and
a right temple:
having a monolithic body coupled to the right rim and having an intermediate right end;
having a right terminal free end;
having a distal right portion including the right terminal free end, selectively removably, solely, and directly fastened to the intermediate right end when in the retracted configuration and defining an intermediate right opening, and having a right magnet coupled thereto and operably configured magnetically coupled to the left magnet; and
defining a right temple channel spanning within the right temple until terminating at the intermediate right opening and having a right flexible corrosion resistant cylindrical cable freely disposed and movable within the right temple channel in a coaxial configuration, the right flexible cylindrical cable having the distal right portion coupled to an end thereon, of a substantially rigid material, and having a flange member coupled thereto, with a flange diameter less than a diameter of the right temple channel and greater than a diameter of the intermediate right opening, and operably configured to restrict longitudinal movement of right flexible cylindrical cable when reaching the intermediate right end.

11. The self-tethering eyeglasses according to claim 10, wherein:
the left and right flexible cylindrical cables are of a metallic material.

12. The self-tethering eyeglasses according to claim 11, wherein:
the left flexible metallic cable having the flange member coupled thereto disposed at a proximal terminal end that is opposite the end with the distal left portion coupled thereto and with the right flexible metallic cable having the flange member coupled thereto disposed at a proximal terminal end that is opposite the end with the distal right portion coupled thereto.

13. The self-tethering eyeglasses according to claim 11, further comprising:
a proximal end of the left temple hingedly coupled to the left rim and a left temple length separating the proximal end of the left temple and the intermediate left end, wherein the left temple channel is at least 95% of the left temple length; and
a proximal end of the right temple hingedly coupled to the right rim and a right temple length separating the proximal end of the right temple and the intermediate left end, wherein the right temple channel is at least 95% of the right temple length.

14. The self-tethering eyeglasses according to claim 10, wherein:
the intermediate left opening is enclosed by the intermediate left end and the intermediate right opening is enclosed by the intermediate right end.

15. The self-tethering eyeglasses according to claim 10, wherein:
the distal left portion includes a planar surface with the left magnet disposed thereon and the distal right portion includes a planar surface with the right magnet disposed thereon.
